(19) United States
(12) Patent Application Publication
(10) Pub. No.: US 2006/0214955 A1
(43) Pub. Date: Sep. 28, 2006

(54) Simplified recording method

(75) Inventors: Pao-Ming Chi, Taipei (TW); Keng-Kok Ang, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/384,495

(22) Filed: Mar. 21, 2006

(30) Foreign Application Priority Data
Mar. 25, 2005 (TW) 94109488

(51) Int. Cl. G01D 15/00

(52) U.S. Cl. 346/137

(57) ABSTRACT

A recording method used in a computer system is provided. The computer system includes a function key and an optical disc drive. After the function key is triggered, the computer system generates an image file according to the data of an optical disc in the optic drive and saves the image file in computer system. After the optical disc in the optic drive is replaced by a blank optical disc, the computer system records the image files to the blank optical disc through the optical disc drive.

This application claims the benefit of Taiwan application Serial No. 94109488, filed Mar. 25, 2005, the subject matter of which is incorporated herein by reference.

### BACKGROUND OF THE INVENTION

1. Field of the Invention

The invention relates in general to a recording method, and more particularly to a recording method for recordable optical disc drive of a computer system.

2. Description of the Related Art

With the popularity of the recordable optical disc, data back-up and disc duplication have become essential functions of computer. The duplication of optical disc is now a common skill used in computer applications. As the recording software is equipped with more versatile functions, the user interface of the recording software provides more options for the user to choose. That is, the user interface of the recording software is getting more and more complicated. However, for an ordinary user, a complicated user interface turns out to be a burden. The user has to learn about the complicated operating interface to achieve the function of disc duplication. Therefore, how to provide a fast and simple procedure for duplicating disc when recording software is equipped with more and more functions has thus become an imminent issue to be resolved.

### SUMMARY OF THE INVENTION

It is therefore an object of the invention to provide a recording method, allowing the user to conveniently duplicate an optical disc in a simple way without incurring any increase in the manufacturing cost of computer hardware.

The invention achieves the above-identified object by providing a recording method used in a computer system. The computer system includes a function key and an optical disc drive. After the function key is triggered, the computer system automatically generates an image file according to the data of an optical disc and saves the image file in computer system. After the optical disc in the optic drive is replaced by a blank optical disc, the computer system auto-records the image files to the blank optical disc through the optical disc drive.

The invention achieves the above-identified object by further providing a recording method for computer system. The computer system includes a function key and an optical disc drive. The recording method includes the following steps. Firstly, the function key is triggered. Then, the computer system requests the to-be-duplicated optical disc to be loaded into the optical disc drive. Next, the computer system checks the data type of the optical disc to generate an image file and saves the image file in computer system. After that, the computer system requests a blank optical disc to be loaded into the optical disc drive. Next, the computer system records the image files to the blank optical disc through the optical disc drive.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of an embodiment of a computer system; and

FIG. 2 is a flowchart of a recording method.

### DETAILED DESCRIPTION OF THE INVENTION

The invention provides a recording method used in a computer system. The computer system at least includes a recordable optical disc drive and a function key. The optical disc drive can be a DVD writer or CD-R writer for instance.

After a certain function key of the optical disc drive or the computer system is triggered, the computer system automatically generates an image file according to the data of an optical disc in the optic drive and saves the image file in the computer system. Next, after the image file is generated, a blank optical disc is placed into the optical disc drive, then the computer system records the image file to the blank optical disc, enabling the user to conveniently duplicate an optical disc using a simple method when the recording interface is getting more and more complicated.

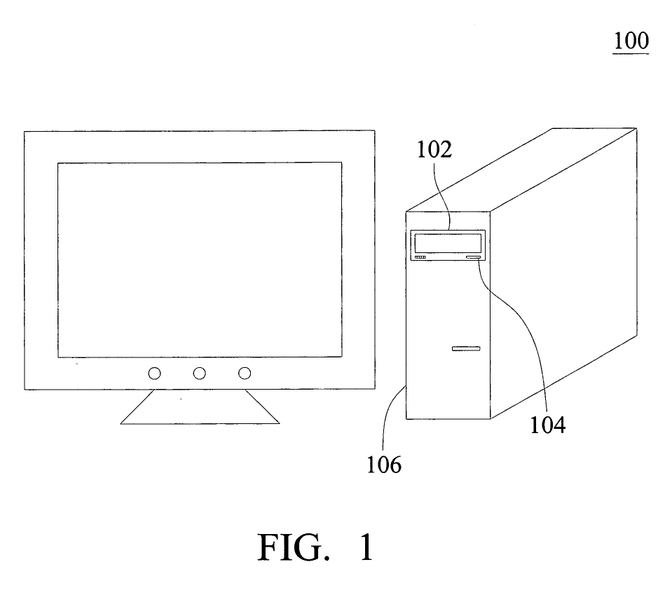

Besides, the above computer system can be a desk-top computer, a notebook computer or a quasi system for instance. The optical disc drive can be internally connected to the computer system. For example, the optical disc drive can be an ordinary optical disc drive mounted on the housing of a desk-top computer or an external optical disc drive connected to the computer system through a USB or other interface. The embodiment of the invention does not limit or specify the type of the optical disc drive and the computer system. The invention is further exemplified by an embodiment. However, the scope of protection of the invention is not limited to the components disclosed in the embodiment. Besides, secondary components are omitted in FIG. 1 in order to highlight the characteristics of the embodiment of the invention.

Refer to FIG. 1, which is a diagram of an embodiment of a computer system. Computer system 100 includes an optical disc drive 102, a function key 104 and a computer host 106. Both the function key 104 and the optical disc drive 102 are electrically connected to the computer host. The computer system 100 can be a desk-top computer for instance. The optical disc drive 102 can be a DVD writer. The function key 104 is for operating the eject function of the optical disc drive 102 such as an eject key on the optical disc drive 102 instance.

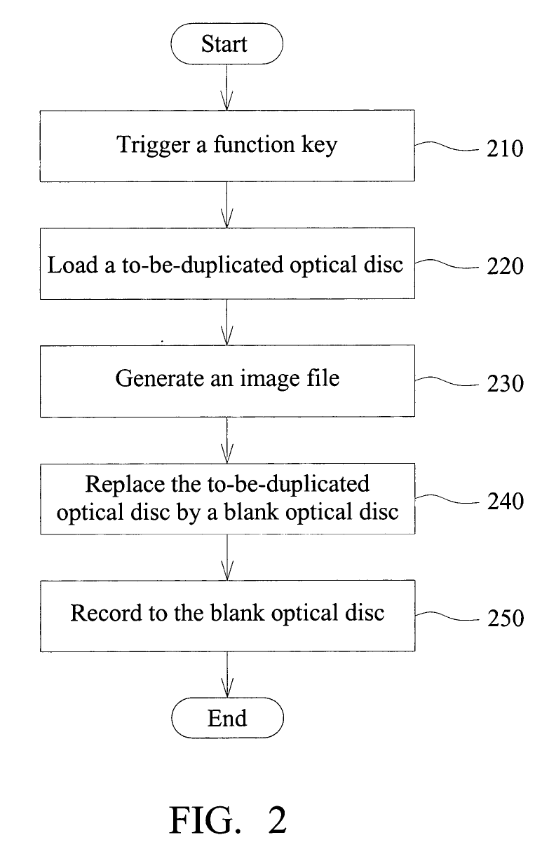

Refer to FIG. 2, which is a flowchart of a recording method. The recording method used in the above computer system 100 includes the following steps. Firstly, the method begins at step 210, a function key 104 is triggered. Next, proceed to step 220, a computer host 106 requests a to-be-duplicated optical disc to be loaded into the optical disc drive 102. Next, proceed to step 230, the computer host 106 checks the data type of the optical disc in order to generate an image file and save the image file in computer host 106. Proceed to step 240, the computer host 106 requests a blank optical disc to be loaded into the optical disc drive 102. At last, proceed to step 250, the computer host 106 records the image file to the blank optical disc through the optical disc drive 102.

Furthermore, after the computer system 100 is booted, an application program of the computer host 106, a recording program for instance, would check whether the optical disc drive support the recording method of the present embodiment. When the optical disc drive 102 responds that the recording method of the present embodiment can be executed, the recording program of the computer host 106 requests the optical disc drive 102 to activate the recording function. Besides, after the recording function of the optical disc drive 102 is activated, the user can also choose an option from the operating system to close the recording function of the optical disc drive 102. Meanwhile, the function key 104 is only for the user to execute eject function. Besides, the function key used for executing play function can be pre-set to execute the recording function.

When the recording function of the optical disc drive 102 is activated and after the function key 104 has been continuously pressed for a period of time (step 210), the recording program of the computer host 106 is requested to execute the recording procedure corresponding to the recording function (the above steps 220 to 250). For example, after the function key 104 of the optical disc drive 102 has been triggered for 3 seconds, the firmware of the optical disc drive 102 would establish a flag. When the flag is enabled, the recording program of the computer host 106 would be informed to execute the recording procedure corresponding to the recording function from one of the polling with optical disc drive 102.

When the computer host 106 is informed to execute the recording procedure corresponding to the recording function, if an optical disc with recorded data has already been loaded into the optical disc drive 102, then the step 230 is executed automatically to check the data type of the optical disc and generate an image file. Otherwise, the recording program displays a user interface to request the user to put a to-be-recorded optical disc into the optical disc drive (step 220).

Proceed to step 230, before the image file is generated, the recording program of the computer host 106 would check first whether the computer host 106 has enough storage space for the image file and then decides whether to generate the image file or not. Next, proceed to step 240, after the image file is generated, the recording program of the computer host 106 would request the user to put a blank disc into optical disc drive, so that in step 250, and then the image file is auto-recorded to the blank optical disc through the optical disc drive 102.

Therefore, after the user has continuously triggered the function key 104 with eject function of the optical disc drive 102 for a period of time, such as 3 seconds for instance, the computer system 100 would execute the above recording method; and if the user does not continuously trigger the function key 104 for the above period of time, the function key 104 still executes the original eject function. An user only needs to load a to-be-recorded optical disc into the optical disc drive and continuously press the eject key of the optical disc drive, the computer system would automatically duplicate the data of the optical disc to the new blank optical disc. The user only needs to load a source disc (a to-be-recorded optical disc) and then replace the to-be-recorded optical disc by a blank optical disc, largely simplifying the complicated procedures of recording an optical disc comparing to a conventional practice.

Besides, the above function key 104 can be the eject key of the optical disc drive or a particular function key of the computer system 100. For example, when the computer system 100 is a notebook computer, the function key can be disposed on the housing of the notebook computer or disposed on the keyboard as a hot key. The function disposed on the keyboard can be a particular function key used for executing recording method or a combination of different keys on the keyboard such as Ctrl+F4 for instance. According to the present embodiment, the function key 104 is not subject to any particular type. Any key capable of executing the recording method of the embodiment after being triggered will do. When the optical disc drive 102 is an external type, the recording method can be automatically executed by continuously triggering the eject function key of the external optical disc drive 102.

The invention is also applicable to a computer system having several optical disc drives. Similarly, after the user has continuously triggered the eject key of one of the optical disc drives for a period of time such as 3 seconds for instance, the computer system would execute the recording function of the invention; and if the user does not continuously trigger the function key for the above period of time, the original eject function is executed.

In addition, when the eject key has been continuously triggered for a period of time, recording function of the optical disc drive is enabled and the computer host executes the recording procedure thereafter. For example, when the eject key of the optical disc drive is triggered for 3 seconds, a flag will be set by executing firmware of the optical disc drive. When the flag is set as an enable type, the recording program will execute the recording procedure corresponding to the recording function during one of the following polling between the host computer and the optical disc drive.

In the present embodiment, the computer system 100 further includes a second optical disc drive (not shown in the FIG. 2). When the computer host 106 is informed of executing the recording procedure corresponding to the recording function, the computer host 106 checks the data type of the optical disc and generates an image file accordingly if an optical disc with data has already been loaded into the first optical disc drive 102; otherwise, the recording program of the computer host 106 displays a user interface on the computer system 100 requesting the user to load the to-be-recorded optical disc into the first optical disc drive 102.

Before generating an image file, the recording program of the computer host 106 would first of all check whether the computer host 106 has enough storage space for storing the image file before deciding whether to generate the image file. Next, after the image file is generated, the recording program of the computer host 106 would request the user to load a blank disc into the second optical disc drive, and then the image file is recorded to the blank optical disc through the second optical disc drive.

Besides, through the first optical disc drive 102 and the recording program of the recording function of the invention, the data of the optical disc with data can be directly duplicated to a blank optical disc loaded in the second optical disc drive without generating an image file, thus saving the time of manufacturing the image file as well as the storage space of storing the image file.

The invention can be applied to a computer system without adding or upgrading any hardware to the optical disc drive or computer system. Moreover, for a single optical disc driver, the optical disc drive is not subject to any brands or models. The recording method of the invention is applicable by upgrading firmware of the optical disc drive only if the optical disc drive is encompassed with an eject key. Such design enables the user to conveniently and cost-wisely achieve a recording function.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A recording method used in a computer system, wherein the computer system comprises a function key and an optical disc drive, and the recording method comprises:
(a) generating an image file according to the data of an optical disc in the optic drive by the computer system and saving the image file in the computer system after the function key is triggered; and
(b) recording the image file to the blank optical disc through the optical disc drive by the computer system after the optical disc in the optical disc drive is replaced by a blank optical disc.

2. The recording method according to 1, wherein the function key is further utilized for triggering the eject function or play function of the optical disc drive, and in the step (a), after the function key has been continuously triggered for a period of time, the computer system automatically generates an image file according to the data of an optical disc in the optic drive and saves the image file in the computer system.

3. The recording method according to 1, wherein the optical disc drive is internally connected to the computer system.

4. The recording method according to 1, wherein the optical disc drive is an external optical disc drive.

5. The recording method according to 1, wherein the computer system is a notebook computer or a desk-top computer.

6. The recording method according to 5, wherein the function key is disposed on the housing of the notebook computer or the desk-top computer.

7. The recording method according to 1, wherein the function key is disposed on the keyboard of the computer system.

8. A recording method for computer system, the recording method comprises:
(a) triggering a function key;
(b) requesting a to-be-duplicated optical disc to be loaded into an optical disc drive by the computer system;
(c) checking the data type of the optical disc by the computer system to generate an image file and save the image file in the computer system;
(d) requesting a blank optical disc to be loaded into the optical disc drive by the computer system; and
(e) recording the image file to the blank optical disc through the optical disc drive.

9. The recording method according to 8, wherein the function key is further utilized for operating the eject function or play function of the optical disc drive, and the step (b) to the step (e) are executed after the function key has been continuously pressed for a period of time.

10. The recording method according to 8, wherein the optical disc drive internally connected to the computer system.

11. The recording method according to 8, wherein the optical disc drive is an external optical disc drive.

12. The recording method according to 8, wherein the computer system is a notebook computer or a desk-top computer.

13. The recording method according to 12, wherein the function key is disposed on the housing of the notebook computer or the desk-top computer.

14. The recording method according to 8, wherein the function key is disposed on the keyboard of the computer system.

15. A computer system used for executing a recording method, wherein the computer system comprises:
a computer host;
a function key electrically connected to the computer host;
a first optical disc drive electrically connected to the computer host; and
a second optical disc drive electrically connected to the computer host;
wherein, the computer host auto-records the data of an optical disc in the first optical disc drive to a blank optical disc of a second optical disc drive after the function key is triggered.

16. The computer system according to 15, wherein the function key is further used for pressing the eject function or play function of the first optical disc drive or the second optical disc drive, and after the function key has been continuously pressed for a period of time, the computer system automatically generates an image file according to the data of an optical disc in the first optical disc drive and saves the image file in the computer system.

17. The computer system according to 15, wherein the first optical disc drive and the second optical disc drive are internally connected to the computer system.

18. The computer system according to 15, wherein the first optical disc drive and the second optical disc drive are external optical disc drives.

19. The computer system according to 15, wherein the computer system further comprises a keyboard on which the function key is disposed.

20. The computer system according to 15, wherein the computer system further comprises a housing on which the function key is disposed.
